(19) United States
(12) Patent Application Publication
(10) Pub. No.: US 2013/0321622 A1
(43) Pub. Date: Dec. 5, 2013

(54) SHIPPING CONTAINER SCANNING SYSTEM

(71) Applicant: Steven Safreno, Woodside, CA (US)

(72) Inventor: Steven Safreno, Woodside, CA (US)

(21) Appl. No.: 13/487,092

(22) Filed: Jun. 1, 2012

(51) Int. Cl. H04N 7/18; G01T 1/00; B65D 88/12

(52) U.S. Cl. 348/143; 220/1.5; 250/395; 348/E07.085

(57) ABSTRACT

A shipping container scanning system includes a control hub container and at least one probe coupled to the control hub container via a wired or wireless connection. The probe is insertable into at least one shipping container. The probe is movable in a hollow interior of the shipping container and scans the hollow interior of the at least one shipping container, generating detection data regarding a presence of a radioactive material in the interior of the shipping container. The probe can include a video camera adapted to monitor the interior of the shipping container and to generate video data responsive thereto. The probe can also include a transmitter adapted to transmit the detection data and the video data to the control hub container. A shipping container usable with the system and a method of scanning shipping containers are also provided.

### FIELD

This invention relates to systems and methods for scanning shipping containers, and in particular, to systems and method for detecting harmful materials in the interior of the shipping containers.

### BACKGROUND

The global trade depends on goods and other cargo to be shipped all over the world in shipping containers via mass transportation vehicles such as ships, planes, trains, or the like. At any given time, millions of shipping containers can be in transit either at sea, on land, or in the air. The shipping containers are typically very bulky and can store a large number of items. In the present times, a growing concern is associated with the transport of harmful devices and weapons-grade materials from country to country via shipping containers. The concern relates both to damage to the goods being transported as a result of an explosion in a shipping container and to potential human casualties that could result from such a blast or radiation leak.

In an attempt to prevent and/or restrict such materials from being included in shipments, many border authorities choose to scan the containers prior to departure from the point of origin and again at the point of destination. Such scans are sometimes performed upon arrival on shore or at off-shore customs/border patrol stations. Scanning shipping containers prior to departure and upon arrival is time-consuming and can significantly slow down trade. Furthermore, scanning a shipping container that contains a conventional or a nuclear bomb at the destination is potentially too late to effectively prevent an attack, and can lead to devastation and human casualties in a densely populated area. Moreover, most conventional scanning systems presently in use scan the shipping containers from outside and may not provide an effective scan of the contents of the shipping containers because most conventional shipping containers are made of steel, which is a material that can shield the radioactive particles on the interior of the containers from a radiation scanner. In addition, scanners that scan from the outside of the steel containers may not detect to some materials (e.g., TNT, toxic gases, chemical or biological weapons) in the interior of the shipping containers.

Accordingly, what is needed is a scanning system that can reliably scan the interior of the shipping containers and detect the presence of any harmful materials therein while the shipping containers are in transit.

### SUMMARY

This invention satisfies such a need. In a preferred embodiment, a shipping container scanning system is provided. The system comprises a control hub container. At least one probe is coupled to the control hub container. The probe is sized and shaped for insertion into at least one shipping container having a hollow interior. The probe is movable in the hollow interior of the at least one shipping container along a length of the at least one shipping container. The probe includes at least one detector adapted to scan the interior of the at least one shipping container and to generate detection data regarding a presence of a radioactive material in the interior of the at least one shipping container. The probe also includes a video camera adapted to monitor the interior of the at least one shipping container and to generate video data regarding materials in the interior of the at least one shipping container. The probe further includes a transmitter adapted to transmit the detection data and the video data to the control hub container.

The shipping container can comprise a housing including a floor, a ceiling, and side walls defining the hollow interior of the shipping container. At least one main access door can be pivotally coupled to the housing and configured to open and close to provide access to the hollow interior of the shipping container. A channel can be mounted to the housing in the hollow interior of the shipping container. An auxiliary access opening can be formed in at least one of the housing and the at least one main access door. The auxiliary access opening can be configured to permit the at least one probe to pass therethrough and at least in part into the channel.

In one approach, the at least one probe can include a remote control mechanism including a receiver configured to permit the at least one probe to be movable in the interior of the at least one shipping container from at least one of the control hub container or a central station.

In another approach, the at least one probe can include at least one wheel to permit the at least one probe to move in at least one direction in the hollow interior of the shipping container.

The system can further comprise a first junction box configured to couple the at least one probe to the control hub container via at least one power line. The first junction box can include at least one input adapted to receive the at least one power line; at least one output connectable to the at least one probe; and a movable member adapted to couple to the at least one probe and to move the at least one probe in at least one direction in the interior of the at least one shipping container.

In one approach, the movable member can be adapted to reciprocate to cause the at least one probe to travel back and forth along the length of the at least one shipping container.

The system can further comprise at least a second junction box and the first junction box can include at least one output adapted to be connected to the second junction box to transmit power from the at least one power line to at least the second junction box. The second junction box can be adapted to couple to a second probe and to removably attach to a second shipping container. The second junction box can be adapted to move the second probe in at least one direction in an interior of the second shipping container. In one approach, the first junction box can include at least one attachment member adapted to removably attach the first junction box to the at least one shipping container.

The control hub container can include a communication system configured to receive the detection data and the video data transmitted from the at least one probe. The communication system of the control hub can be in communication with a central station and configured to forward the detection data and the video data transmitted from the at least one probe to the central station.

The control hub can include a rotatable spool comprising at least one power line. The rotatable spool can comprise a plurality of cables extending therefrom, each of the cables being connected to a probe.

In one approach, the channel can extend along a majority of the length of the at least one shipping container. The channel can include at least one transparent surface. The channel can include at least one engaging member adapted to mate with the at least one probe. The engaging member can be movable in at least one direction along the channel to move the at least one probe in at least one direction in the channel. The channel can be mounted to the ceiling of the hollow interior of the shipping container.

The shipping container can include at least one auxiliary door covering the auxiliary access opening. The at least one auxiliary door can be engaged to the at least one main access door and adapted to be opened by at least one of sliding, swiveling, or pivoting.

A method of scanning shipping containers using the container scanning system comprises: positioning the at least one probe proximate the auxiliary access opening in the at least one shipping container; inserting the at least one probe through the auxiliary access opening and into the channel in the hollow interior of the shipping container; moving the at least one probe in the channel along at least a portion of the length of the shipping container; scanning, using the probe, the hollow interior of the shipping container for radioactive materials; and generating, using the probe, the detection data regarding the presence of the radioactive material in the hollow interior of the shipping container.

A method of scanning shipping containers is also provided. The method comprises: providing a central hub container including at least one radioactive material-detecting probe coupled thereto; providing at least one shipping container including a hollow interior having a ceiling and a floor, at least one access door, and an auxiliary access opening formed in the at least one access door; permitting the probe to be inserted through the auxiliary access opening and into the hollow interior of the shipping container; permitting the at least one probe to move in at least one direction above the floor of the hollow interior of the shipping container; scanning, using the probe, the hollow interior of the shipping container for radioactive materials; and generating, using the probe, detection data regarding a presence of at least one radioactive material in the hollow interior of the shipping container.

A shipping container is also provided. The container comprises a housing including a floor, a ceiling, and side walls defining a hollow interior of the shipping container, the hollow interior having a length. The shipping container includes at least one main access door pivotally coupled to the housing and configured to open and close to provide access to the hollow interior. The container further includes a channel mounted to the housing in the hollow interior of the shipping container. The channel is adapted to permit a radioactive material detecting probe to travel in at least one direction along the channel in the hollow interior of the shipping container. The container further comprises an auxiliary access opening formed in at least one of the housing and the at least one main access door. The auxiliary access opening is configured to permit the probe to pass therethrough and at least in part into the channel.

The scanning system and methods described therein provide numerous advantages over the presently used systems and methods. One advantage is that the scanning system in a preferred embodiment scans the shipping containers while they are in transit, preventing time delays associated with scanning the shipping containers at the destination location. Another advantage is that the scanning system in a preferred embodiment scans the shipping containers from the interior of the shipping containers and can detect materials and gases in the interior which would not be detectable from the outside. Yet another advantage is that the scanning system in a preferred embodiment monitors the interior of the shipping containers using a camera and can transmit a live feed or recorded images or video to a control hub. Further advantages will be appreciated by those of ordinary skill in the art with reference to the following drawings, detailed description, and claims.

### BRIEF DESCRIPTION OF THE DRAWINGS

FIG. 1 side elevational view of a cargo ship including the shipping container scanning system according to one embodiment, shown with the containers in partial cross-section;

FIG. 2 is a perspective sectional view of a control hub container according to a preferred embodiment;

FIG. 3 is a perspective sectional view of a control hub container according to another preferred embodiment;

FIG. 4 is a side sectional view of two shipping containers being scanned by the scanning system according to one embodiment, shown with a power line being connected to a first junction box and the first junction box being connected to a probe and a second junction box;

FIG. 5 is an enlarged fragmentary side sectional view of a shipping container of FIG. 4 showing the first junction box being engaged to the shipping container;

FIG. 6 is a front perspective view of a probe according to a preferred embodiment, shown coupled to a cable;

FIG. 7 is a front elevational view of a shipping container according to a preferred embodiment, shown with an auxiliary access opening and a channel proximate a top of the shipping container;

FIG. 8 is front perspective view of the shipping container of FIG. 7 with the main access doors being open and showing the hollow interior of the shipping container including the channel; and

FIG. 9 is a rear fragmentary view of the hollow interior of the shipping container of FIG. 7, showing the channel mounted in the hollow interior of the shipping container and a probe in the channel.

### DETAILED DESCRIPTION

Reference will now be made in detail to the present preferred embodiments of the invention, examples of which are illustrated in the accompanying drawings.

Generally, a shipping container scanning system includes a plurality of probes insertable into a plurality of shipping containers to check for the presence of radioactive or other harmful materials in the shipping containers. For purposes of this application, a probe will be understood to mean any device capable of scanning a given structure or area and detecting the presence of harmful materials, including, but not limited to, radioactive materials, chemical weapon-grade materials, biological weapon-grade materials, and explosive materials. The probes can be connected to, or can be in communication with, a control hub container or a central station, and can transmit detection data and/or video data to the control hub container and/or the central station. The control hub container can be positioned on top of a stack of shipping containers being transported in a cargo ship or a train and the probes can be inserted into each of the shipping containers being transported to check for the presence of radioactive materials. Accordingly, the shipping containers can be checked for the presence of harmful materials while in transit, preventing time-consuming security scans and delays in shipping, receiving, and/or processing the cargo when the cargo leaves the location of origin and/or arrives at the destination.

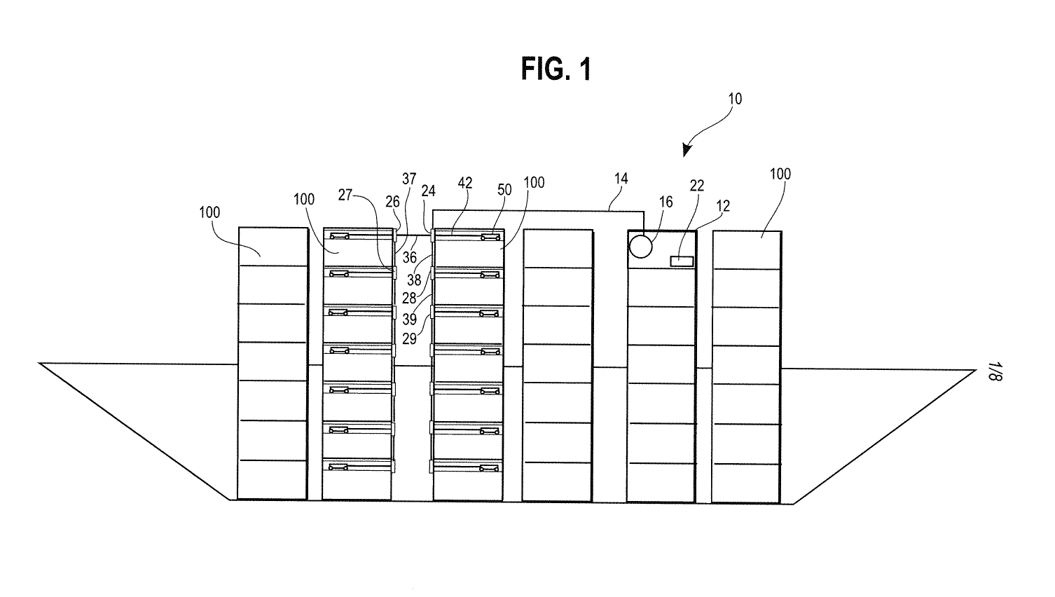

A cargo ship transporting a plurality of shipping containers 100 and including the scanning system 10 according to a preferred embodiment of the present invention is shown in FIG. 1. Although a ship has been illustrated in FIG. 1, it is to be appreciated that the scanning systems and methods described herein can be used in any area where cargo is stored or transported, for example, a train, a plane, a truck, a warehouse, or the like. The shipping containers 100 are typically transported aboard cargo ships in multiple stacks as shown in FIG. 1.

The container scanning system 10 includes a control hub container 12 and a plurality of probes 50. The control hub container 12 can be positioned on top of any of the stacks of the shipping containers 100 as shown in FIG. 1, but may optionally be positioned in a different location, for example, between two containers 100, at the bottom of the stack of containers 100, or in a location separate from the stacks of containers 100. The probes 50, which will be discussed in more detail below, can be connected to the control hub container 12 and are insertable into the shipping containers 100 to detect the presence of harmful materials in the interior of the shipping containers 100.

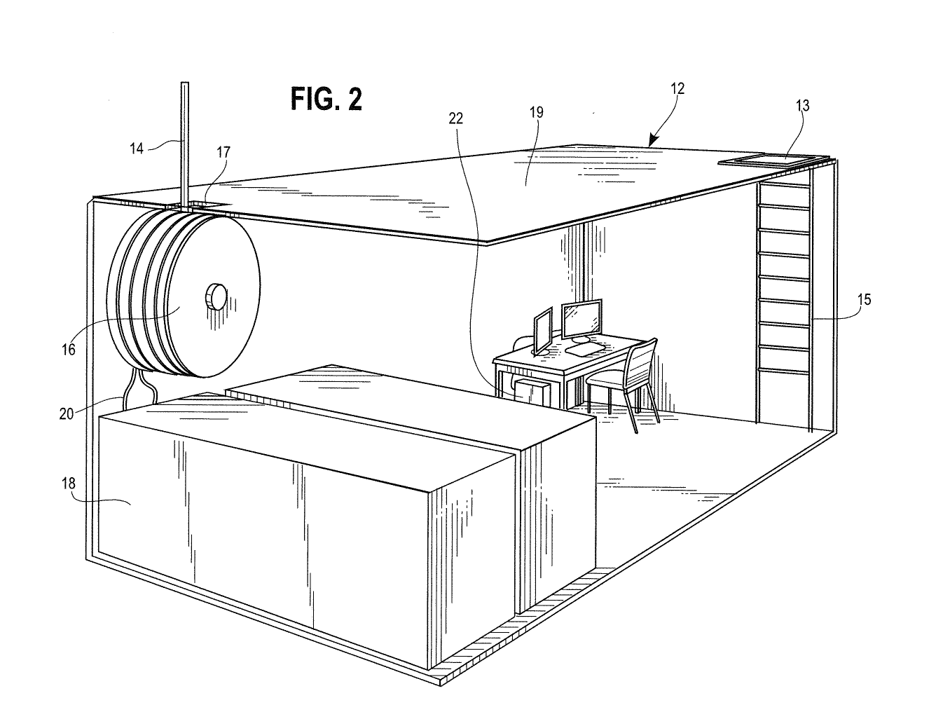

With reference to FIG. 2, a control hub container 12 according to one preferred embodiment is described. The control hub container 12 includes a retractable power line 14 which can extend from the control hub container 12 through a slot 17 formed in the roof 19 of the control hub container 12, and is connectable to one or more devices requiring a power source as described in more detail below. The power line 14 is wound on a rotatable spool 16 as shown in FIG. 2 and can be of a length suitable to extend from the control hub container 12 to a shipping container 100 desired to be scanned. For example only, the power line 14 can be from 30-50 feet in length. While a rotatable spool 16 is shown in FIG. 2, it is to be appreciated that the power line 14 can be coupled to any suitable device that would permit the power line 14 to be extendable and retractable. The control hub container 12 can include a power generator 18 and electrical wiring 20 to provide power to the rotatable spool 16 and to any other device in the control hub container 12 that requires power.

With reference to FIG. 2, the control hub container 12 includes a communication system 22. The communication system 22 can be in the form of a computer station that is network-enabled so that it can receive data and transmit data via a wireless or a wired connection. For example, the communication system 22 can receive data from a central station and one or more probes 50 used to scan the shipping containers 100 for the presence of harmful materials; transmit data received from such devices to the central station; and transmit data and/or commands to the devices. The communication system 22 is operable by a human operator who can enter the interior of the control hub container 12 via an access hatch 13 using, for example, a ladder 15.

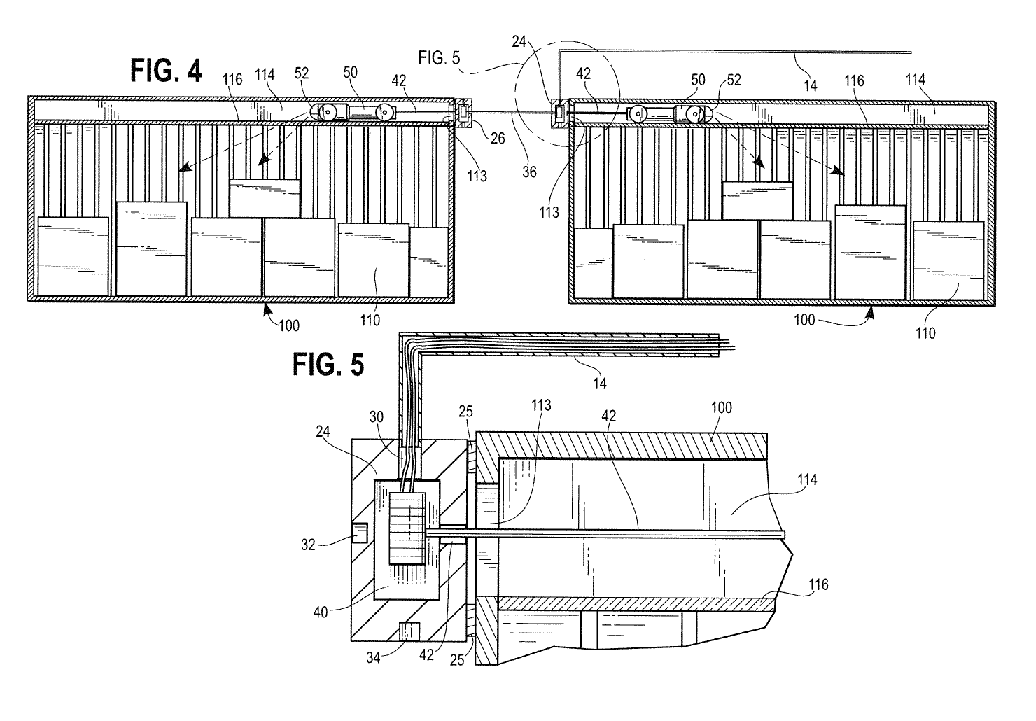

Referring to FIGS. 1 and 4, the power line 14 extends from the control hub container 12 and connects to a junction box 24. For example, an operator can unwind the power line 14 from the spool 16 and plug the power line 14 into the junction box 24, via a pin, male-female, or any suitable connection. The junction box 24 can transmit power from the power line to one or more devices electrically coupled to the junction box 24 as described in more detail below.

With reference to FIG. 5, the junction box 24 includes at least one attachment member 25 that can be used to removably attach the junction box 24 to the shipping container 100. Since the shipping containers 100 are typically made from metal, for example, steel, the attachment members 25 can be magnets, but may instead be in the form of hooks, clasps, or the like. The junction box 24 includes a socket-type connector 30 adapted to receive the power line 14 to provide power to the junction box 24. It is to be appreciated that optionally, the junction box 24 may have its own power source such as a battery pack or the like. The junction box 24 further includes socket-type connectors 32 and 34, which permit the junction box 24 to be electrically coupled, for example, via auxiliary cables 36 and 38, or any suitable means, to junction boxes 26 and 28 respectively, as shown in FIG. 1. With continuing reference to FIG. 1, the junction boxes 26 and 28 can be connected to additional junction boxes 27 and 29 via auxiliary cables 37 and 39. The junction boxes 27 and 29 can connect to additional junction boxes via auxiliary cables such that a junction box can be attached to each of the shipping container 100 in the opposing stacks.

Referring to FIG. 5, the junction box 24 further includes a movable member 40 adapted to mechanically and/or electrically couple the junction box 24 to a device configured for scanning shipping containers 100 for the presence of harmful materials. The movable member 40 can be a manually or mechanically rotatable winch or spool including a connector 42 that can be coupled to a device such as the radioactive material-detecting probe 50. The movable member 40 can be powered by the power line 14 plugged into the socket 30 of the junction box 24 as shown in FIG. 5, or may be battery-powered. The movable member 40 can move the connector 42 in at least one direction. Preferably, the movable member 40 can move the connector 42 and a device (e.g., the probe 50) attached to the connector 42 both in a direction away from the junction box and in a direction toward the junction box 24. The movable member 40 can be a reciprocating device capable of moving the connector 42 and the probe 50 attached to the connector 42 along the length of the shipping container 100.

If the probe 50 is a device that requires external power, the connector 42 can be a power cable that would provide power to the probe 50 when the connector 42 is plugged into the probe 50. If the probe 50 is a battery powered device, the connector 42 can be a cable that simply couples the probe 50 to the junction box 24 without providing power to the probe 50. Preferably, the connector 42 is sufficiently rigid such that a device such as the probe 50 connected to the connector 42 can be pushed forward via the movable member 40. For example, the connector 42 may be at least in part metalized or made of a sufficiently rigid plastic material.

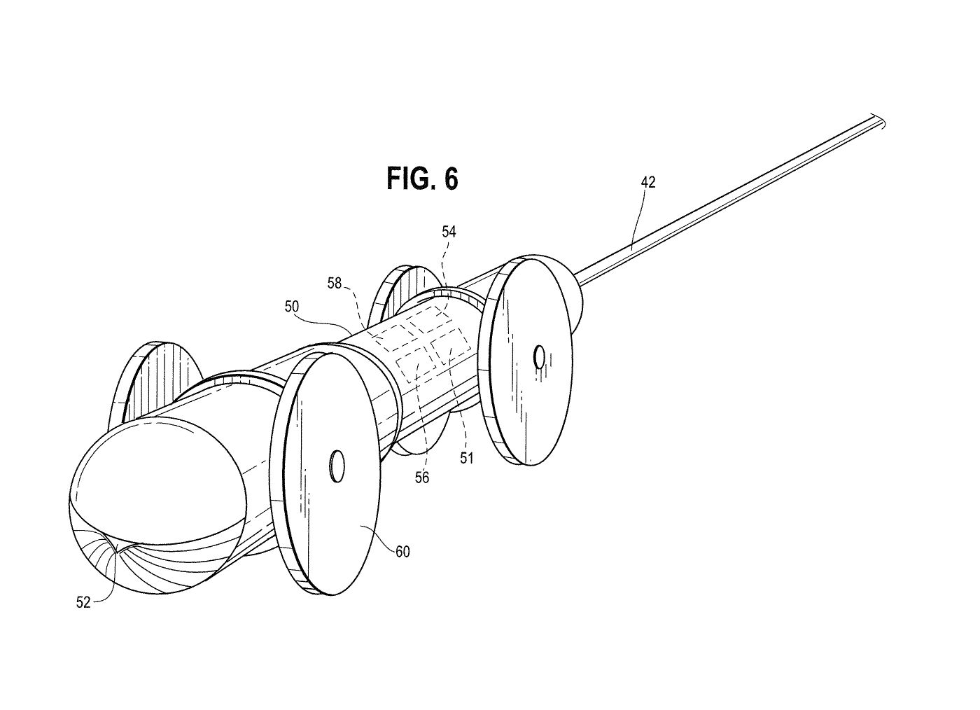

With reference to FIG. 6, a preferred embodiment of the probe 50 will now be described. The probe 50 can be an isotope-detecting device similar to SAM 940 manufactured by Berkeley Nucleonics Corporation. The probe 50 is equipped with at least one detector 51 capable of identifying radioactive isotopes, including, but not limited to cadmium-109, cobalt-60, strontium-90, thallium-204, tritium, uranium-238, cesium-137, americium-241, and the like, which can be used in nuclear-grade weapons and/or explosive devices such as so-called “dirty bombs.” The range of the probe 50 can be such that when the probe 50 is positioned in the interior of the shipping container 100, the detector 51 of the probe 50 can scan the entire interior of the shipping container 100 and the cargo 110 stored in the shipping container 100, and to generate detection data regarding the presence of harmful materials. The probe 50 can also be equipped with a memory 56, a processor 58, and one or more detectors capable of scanning the interior of a shipping container 100 to detect the presence of any one of explosive materials such as conventional bombs; biological weapon-grade materials, and chemical weapon-grade materials. The probe 50 can also be equipped with one or more sensors that would scan and test the air inside of a shipping container for the presence of harmful materials such as toxic gases.

With reference to FIG. 6, the probe 50 includes a video camera 52. The video camera 52 has been shown as being mounted on the front of the probe 50, but can be mounted on any suitable location on the probe 50. The video camera 52 can be mounted such that it can move in different directions, for example, by swiveling. The video camera 52 can be a conventional camera capable of providing a live feed, snapping still images, and recording video data, and may optionally be equipped with night-vision and/or thermal sensors. When the probe 50 is positioned, or moves in the interior of the shipping container 100, the video camera 52 can monitor the cargo stored in the shipping container and continuously generate video data, which can be saved in the memory 56 of the probe 50 or streamed directly to the control hub container 12 or a remote central station.

The probe 50 further includes at least one transmitter 54. The transmitter 54 can be any transmitter capable of transmitting signals in real-time to the communication system 22 in the control hub container 12 or to a central station, which can be located elsewhere on the cargo ship or any other transportation vehicle carrying the shipping containers 100, or on the mainland, for example, in the country of origin from which the goods are shipped, in the destination country to which the goods are shipped, or in any country other than the country of origin or country of destination. The transmitter 54 is adapted to transmit the detection data generated by the detector 51 or other detectors and the video data generated by the video camera 52. As shown in FIG. 6, wheels 60 can be mounted on the probe 50 to permit the probe 50 to be movable in at least one direction in the interior of a shipping container 100. Instead of the wheels 60, the probe 50 may be optionally equipped with one or more elements that would permit the probe 50 to mate with a corresponding structure mounted in the interior of the shipping container via, for example, a track assembly, a pulley assembly, or the like.

In a preferred embodiment, the probe 50 includes a socket-type input that permits a power line or a cable to be connected to the probe 50. For example, as shown in FIGS. 4-6, the connector 42 of the movable member 40 of the junction box 24 can be coupled to the probe 50, providing for movement of the probe 50 in response to movement of the movable member 40. Alternatively, the probe 50 can be connected to a cable or power line that is not coupled to the movable member 40 and the probe 50 can be pushed into the shipping container 100 or pulled out of the container 100 via a hand of a human operator or rotation of the spindle 16 in the control hub container 12. In one approach, the probe 50 may be equipped with a remote control mechanism including a receiver that would permit the probe 50 to be coupled to the control hub container 12 and be movable via the communication system 22 in the control hub container 12. Optionally, the probe 50 can be movable via a separate remote controller or from a central station remote to the ship.

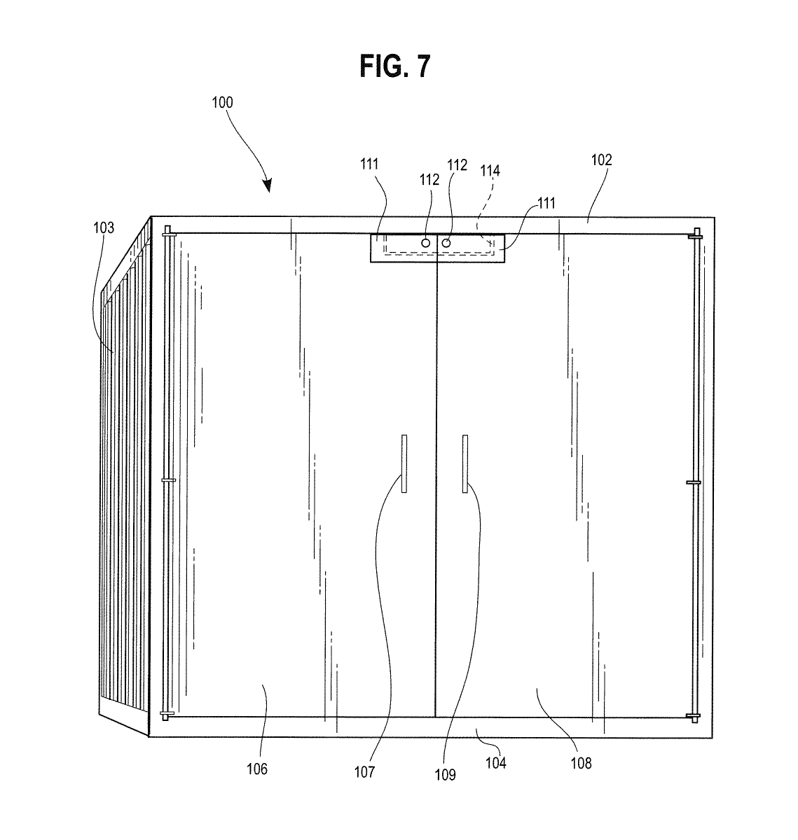

Referring to FIGS. 7-9, a preferred embodiment of the shipping container 100 is described. The shipping container 100 is similar to the conventional shipping containers currently used to transport cargo, goods, and other materials in that it is made from a metal such as steel and has a top 102, a bottom 103, and a side wall 103 connecting the top 102 and the bottom 103, together defining a hollow interior of the shipping container 100 therebetween. The shipping container 100 further includes main access doors 106 and 108, which can be swung open via handles 107 and 109, respectively.

The shipping container 100 is different from conventional containers in that it includes one or more auxiliary doors 111. When closed, the auxiliary doors 111 cover an auxiliary opening 113 in the container 100 through which the probe 50 can be inserted into the container 100 while the main access doors 106 and 108 are closed. As such, the container 100 can be fully closed until a user determines a need to open the auxiliary doors 111 to insert the probe 50 into the container 100. The auxiliary doors 111 can be opened via handles or knobs 112 to reveal the auxiliary opening 113 and provide access into the hollow interior of the container 100 while the main access doors 106 and 106 remain closed. While FIG. 7 shows that the auxiliary doors 111 are formed in each of the main access doors 106 and 108, the one or more auxiliary doors 111 may be optionally formed in only one of the main access doors 106 and 108, the top 102, side wall 103, or the bottom 104 of the shipping container 104.

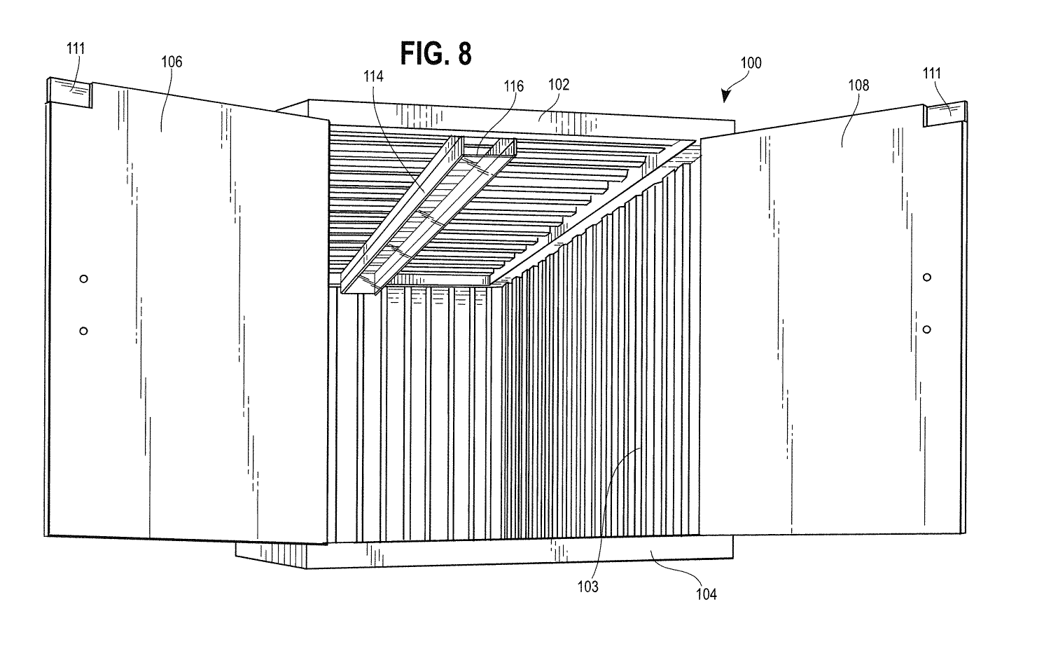

Referring to FIG. 8, the shipping container 100 includes a channel 114 that permits the probe 50 to travel in at least one direction in the interior of the container 100. For purposes of this application, a channel will be understood to mean any device mounted at least in part in the interior of the container 100 and capable of providing a surface on which or along which the probe 50 can travel, or a structure that can engage the probe 50 and facilitate the probe 50 in moving in the interior of the shipping container 100. The channel 114 can be U-shaped and mounted at the top 102 of the container 100. The channel 114 is preferably mounted at or near the top 102 of the shipping container 100 to permit the channel 114 to extend along the length of the hollow interior of the container 100 without being obstructed or impeded by the cargo 110 stored in the shipping container, which is typically stored on the floor of the container 100 with room left near the top 102 of the container, as shown in FIG. 4. The channel 114 can extend along a portion of, a majority of, or the entire length of the hollow interior of the shipping container 100, as shown in FIG. 8.

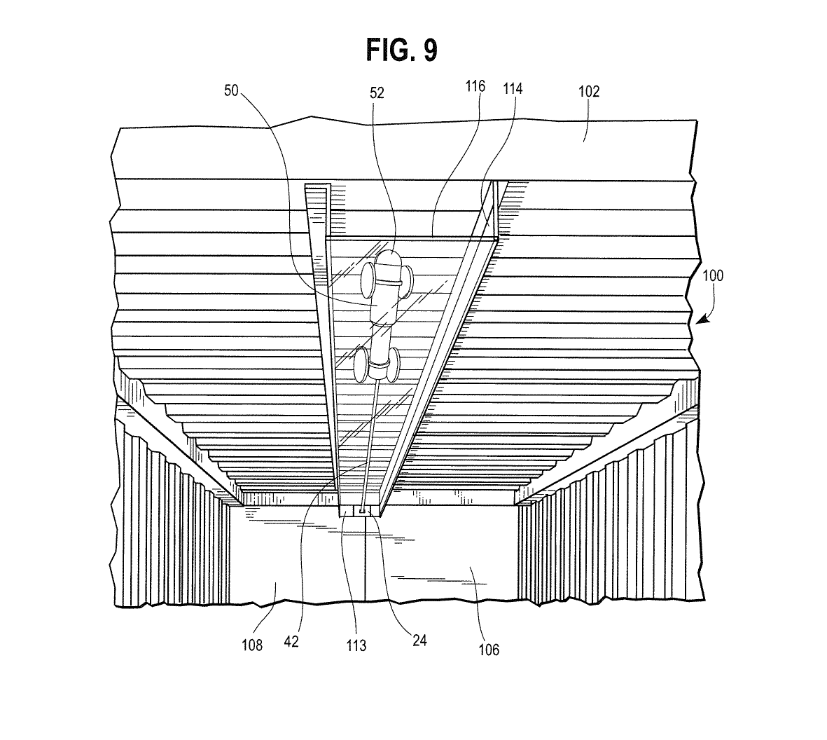

Referring to FIG. 9, the channel 114 can be made of plastic, fiberglass, or the like materials and can be made by injection molding or other suitable techniques. The channel 114 can include at least one transparent surface 116 as shown in FIG. 9. The surface 116 or the side walls of the channel 114 may optionally include one or more apertures to permit the probe 50 to test the air in the interior of the shipping container 100. As shown in FIG. 9, the probe 50 inserted into the hollow interior of the shipping container 100 through the auxiliary access opening 113 can travel on the surface 116 of the channel 114 along the length of the hollow interior of the shipping container 100. For example, the probe 50 can be pushed forward and/or retracted in the channel 114 via the connector 42 coupled to the movable member 40 of the junction box 24 as shown in FIG. 9.

In one approach discussed further below, the probe 50 can be connected to a cable or power line similar to the connector 42 and moved directly by the operator. In another approach, the probe 50 can be battery-powered and remote control-operated (via a stand-alone remote control or the communication system 22) to travel forward and backward within the channel 114. The transparent surface 116 of the channel 114 permits the video camera 52 of the probe 50 to take snap shots or film the interior of the shipping container 100 without being obstructed.

It is to be appreciated that while the channel 114 that permits the probe 50 to travel in the interior of the shipping container 100 has been shown as U-shaped with a surface on which the probe 50 can move, the channel 114 may be in the form of various devices that can engage the probe 50 while permitting movement of the probe 50 in at least one direction. Devices suitable for forming the channel 114 can be a track assembly, a pulley assembly, or the like.

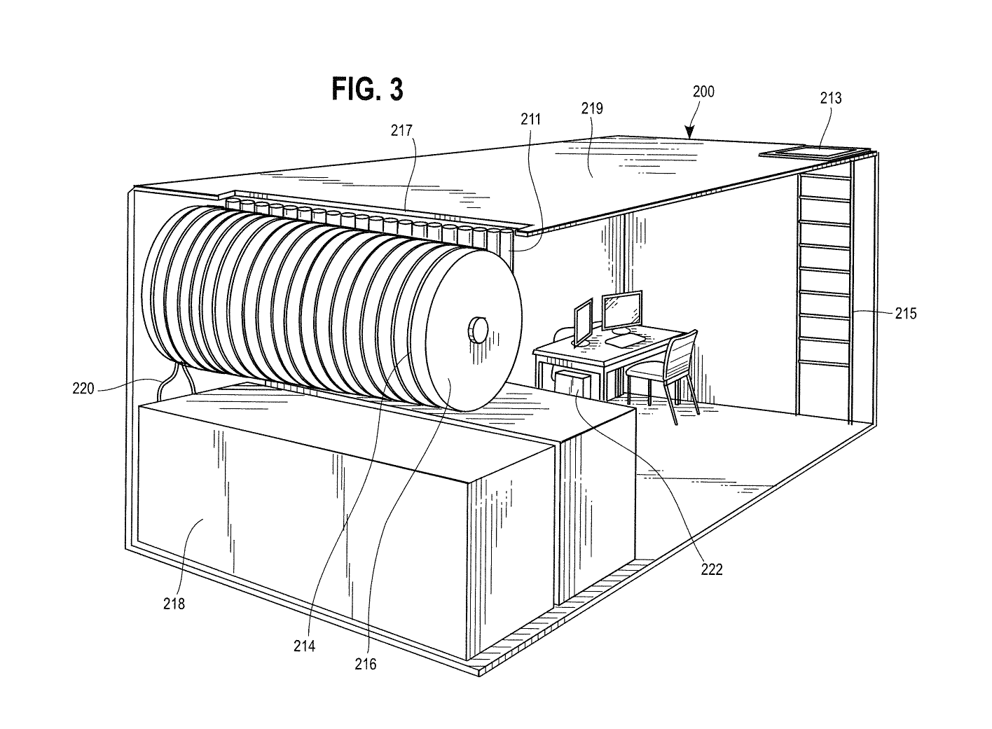

With reference to FIG. 3, a control hub container 200 according to another preferred embodiment is described. The control hub container 200 is similar to the control hub container 12 in that it includes a rotatable spool 216. The control hub container 200 can include a power generator 218 and electrical wiring 220 to provide power to the rotatable spool 216. The control hub container 200 includes a communication system 222 substantially identical to the communication system 22 described above. The communication system 222 is operable by a human operator who can enter the interior of the control hub container 200 via an access hatch 213 using, for example, a ladder 215.

Instead of the retractable power line 14 which can extend from the control hub container 12 and connect to one or more junction boxes 24 as described above, the spool 216 of the control hub container 200 includes a plurality of cables 214. Each cable 214 includes a tubular end member 211 that can receive and house the probe 50 therein. The probes 50 can be retrieved and extended away from the tubular members 211 through a slot 217 formed in the roof 219 of the control hub container 200. The probes 50 can be extended away from the control hub container 200 for as long as the length of the cables 214 will permit. Preferably, the length of each cable 214 is sufficient to extend the probe 50 away from the control hub container 200 and into the target shipping container 100 desired to be scanned by the probe 50.

In one approach, each probe 50 requires auxiliary power and each cable 214 is an electrical cable and acts as a power line providing power to a respective probe 50 coupled thereto. In this approach, the cable 214 may be removed from the probe 50 before, during, or after the insertion of the probe 50 into the shipping container 100, and the cable 214 and the probe 50 may be connected to a junction box 24 described above, which would facilitate movement of the probe 50 in the interior of the shipping container 100. In another approach, the probe 50 is battery-powered and each of the cables 214 is not an electrical cable. In this approach, the probes can be moved back and forth along the interior of a shipping container 100 via the operator's manipulation of the respective cable 214 coupled to the back end of the probe 50.

A method of using a preferred embodiment of the scanning system 10 is now described. As described above, the probe 50, can be coupled to the control hub via a wired connection such as the connector 42, junction box 24, and power line 14, or a wireless connection via a remote control device such as the communication system 22. In use, an operator positions the probe 50 proximate the auxiliary access opening 113 in the shipping container 100. The operator then inserts the probe 50 through the auxiliary access opening 113 and into the channel 114 in the hollow interior of the shipping container 100. The probe 50 is then moved in the channel 114 along at least a portion of the length of the shipping container 100. As discussed above, the probe 50 can either be moved directly by the operator, by the movable member 40 of the junction box 24, or by a remote control. While causing the probe 50 to move in the channel 114, the operator uses the probe 50 to scan the hollow interior of the shipping container for harmful materials discussed above. Further, the operator uses the probe 50 to generate the detection data regarding the presence of the radioactive material in the hollow interior of the shipping container 100.

The scanning system 10 as described above can be used to effectively scan shipping containers 100 while they are in transit, detect harmful materials and/or gases in the interior of the shipping containers 100, and transmit real-time detection and/or video data generated from scanning the interior of the shipping containers 100 to the central hub container 12 or to a remote central station located in the country of origin, the country of destination, or any other location.

The scanning system 10 and methods described therein are advantageous over the presently used systems and methods at least because the containers 100 are scanned while they are in transit, avoiding delays in processing at shipping origin/destination. In addition, the containers 100 are scanned from within their interior, providing a more accurate and thorough scan than presently used systems that are used from the outside of the shipping containers. In addition, detection data regarding the materials in the shipping containers and video data showing a live feed or recorded images or video can be sent to a control hub where the materials can be analyzed before they arrive at a destination.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. A shipping container scanning system comprising:
a control hub container;
at least one probe coupled to the control hub container, the probe being sized and shaped for insertion into at least one shipping container having a hollow interior, the probe being movable in at least one direction in the hollow interior of the at least one shipping container along a length of the at least one shipping container, the probe including:
at least one detector adapted to scan the interior of the at least one shipping container and to generate detection data regarding a presence of a radioactive material in the interior of the at least one shipping container;
a video camera adapted to monitor the interior of the at least one shipping container and to generate video data regarding materials in the interior of the at least one shipping container; and
a transmitter adapted to transmit the detection data and the video data to the control hub container.

2. The system of claim 1, wherein the at least one shipping container comprises:
a housing including a floor, a ceiling, and side walls defining the hollow interior of the shipping container;
at least one main access door pivotally coupled to said housing and configured to open and close to provide access to the hollow interior of the shipping container;
a channel mounted to the housing in the hollow interior of the shipping container;
an auxiliary access opening formed in at least one of the housing and the at least one main access door, the auxiliary access opening being configured to permit the at least one probe to pass therethrough and at least in part into the channel.

3. The system of claim 1, wherein the at least one probe includes a remote control mechanism including a receiver configured to permit the at least one probe to be movable in the interior of the at least one shipping container from at least one of the control hub container or a central station.

4. The system of claim 1, wherein the at least one probe includes at least one wheel to permit the at least one probe to move in at least one direction in the hollow interior of the shipping container.

5. The system of claim 1, further comprising a first junction box configured to couple the at least one probe to the control hub container via at least one power line, the first junction box including:
at least one input adapted to receive the at least one power line;
at least one output adapted to be connected to the at least one probe; and
a movable member adapted to couple to the at least one probe and to move the at least one probe in at least one direction in the interior of the at least one shipping container.

6. The system of claim 5, wherein the movable member is adapted to reciprocate to cause the at least one probe to travel back and forth along the length of the at least one shipping container.

7. The system of claim 5, further comprising at least a second junction box, the first junction box including at least one output adapted to be connected to the second junction box to transmit power from the at least one power line to at least the second junction box, the second junction box being adapted to couple to a second probe and to removably attach to a second shipping container, the second junction box being adapted to move the second probe in at least one direction in an interior of the second shipping container.

8. The system of claim 5, wherein the first junction box includes at least one attachment member adapted to removably attach the first junction box to the at least one shipping container.

9. The system of claim 1, wherein the control hub container includes a communication system configured to receive the detection data and the video data transmitted from the at least one probe.

10. The system of claim 9, wherein the communication system of the control hub is in communication with a central station and is configured to forward the detection data and the video data transmitted from the at least one probe to the central station.

11. The system of claim 1, wherein the control hub includes a rotatable spool comprising at least one power line.

12. The system of claim 1, wherein the rotatable spool comprises a plurality of cables extending therefrom, each of the cables being connected to a probe.

13. The system of claim 2, wherein the channel extends along a majority of the length of the at least one shipping container.

14. The system of claim 2, wherein the channel includes at least one transparent surface.

15. The system of claim 2, further comprising at least one auxiliary door covering the auxiliary access opening, the at least one auxiliary door being engaged to the at least one main access door and adapted to be opened by at least one of sliding, swiveling, or pivoting.

16. The system of claim 2, wherein the channel includes at least one engaging member adapted to mate with the at least one probe, the engaging member being movable in at least one direction along the channel to move the at least one probe in the at least one direction along the channel.

17. The system of claim 2, wherein the channel is mounted to the ceiling of the hollow interior of the shipping container.

18. A method of scanning shipping containers using the system of claim 2, the method comprising:
positioning the at least one probe proximate the auxiliary access opening in the at least one shipping container;
inserting the at least one probe through the auxiliary access opening and into the channel in the hollow interior of the shipping container;
moving the at least one probe in the channel along at least a portion of the length of the shipping container;
scanning, using the probe, the hollow interior of the shipping container for radioactive materials; and
generating, using the probe, the detection data regarding the presence of the radioactive material in the hollow interior of the shipping container.

19. A method of scanning shipping containers comprising:
providing a central hub container including at least one radioactive material-detecting probe coupled thereto;
providing at least one shipping container including a hollow interior having a ceiling and a floor, at least one access door, and an auxiliary access opening formed in the at least one access door;
permitting the probe to be inserted through the auxiliary access opening and into the hollow interior of the shipping container;
permitting the at least one probe to move in at least one direction above the floor of the hollow interior of the shipping container;
scanning, using the probe, the hollow interior of the shipping container for radioactive materials; and
generating, using the probe, detection data regarding a presence of at least one radioactive material in the hollow interior of the shipping container.

20. A shipping container comprising:
a housing including a floor, a ceiling, and side walls defining a hollow interior of the shipping container, the hollow interior having a length;
at least one main access door pivotally coupled to the housing and configured to open and close to provide access to the hollow interior;
a channel mounted to the housing in the hollow interior of the shipping container, the channel being adapted to permit a radioactive material detecting probe to travel in at least one direction along the channel in the hollow interior of the shipping container; and
an auxiliary access opening formed in at least one of the housing and the at least one main access door, the auxiliary access opening being configured to permit the probe to pass therethrough and at least in part into the channel.
